(19) United States
(12) Patent Application Publication
(10) Pub. No.: US 2007/0046446 A1
(43) Pub. Date: Mar. 1, 2007

(54) Alarm device for altering opening of vehicle door

(76) Inventor: Ying-Chieh Chang, Yong Kang City (TW)

Correspondence Address: Ying-Chieh CHANG, P.O. Box 90, Tainan City, 70499, TW

(21) Appl. No.: 11/216,121

(22) Filed: Sep. 1, 2005

(51) Int. Cl. B60R 25/10

(52) U.S. Cl. 340/426.28

(57) ABSTRACT

An alarm device for altering opening of a vehicle door has two rear view mirrors installed at two sides of a vehicle; each rear view mirror being installed with a detection radar; each radar having conductive wires; the conductive wires being connected to a door draw bar and a speech device for informing or alerting the driver that there are cars come from the back side of the vehicle. When the vehicle is stopped, the driver or passenger desire to open the door to leave from the car, the draw bar is pulled so as to actuate the detection radar. When the radar detects that there are cars come from the backside; the speech device will be actuated to alert the drivers or passengers not to open the door.

### FIELD OF THE INVENTION

The present invention relates to vehicle safety devices, and in particular to an alarm device for altering opening of a vehicle door. When a vehicle is stopped, the driver or passenger desire to open the door to leave from the car. The draw bar 11 is pulled so as to actuate the detection radar. When the radar detects that there are cars come from the backside. The speech device will be actuated to alert the drivers or passengers not to open the door.

### BACKGROUND OF THE INVENTION

In driving, the cars from the backside often induce some accidents, which cannot be avoided effectively. This is because the cars from the backside cannot be viewed clearly and is not within the viewing range of the drivers or passengers. The vehicles from the backsides will collide the car doors, even the drivers of the vehicles, for example, drives of motorcycles, will fall down due to the collision to the car door. Moreover, if the car at the front side desires to stop, in the prior art only alert lights are installed at the car, no other alert device is added for informing the car at the rear sides. Thus it is easily occurred that the car at the rear side will collide the car the front side.

### SUMMARY OF THE INVENTION

Accordingly, the primary object of the present invention is to provide an alarm device for altering opening of a vehicle door. When the vehicle is stopped, the driver or passenger desire to open the door to leave from the car. The draw bar 11 is pulled so as to actuate the detection radar. When the radar detects that there are cars come from the backside. The speech device will be actuated to alert the drivers or passengers not to open the door.

To achieve above object, the present invention provides an alarm device for altering opening of a vehicle door has two rear view mirrors installed at two sides of a vehicle; each rear view mirror being installed with a detection radar; each radar having conductive wires; the conductive wires being connected to a door draw bar and a speech device for informing or alerting the driver that there are cars come from the back side of the vehicle. When the vehicle is stopped, the driver or passenger desires to open the door to leave from the car, the draw bar is pulled so as to actuate the detection radar. When the radar detects that there are cars come from the backside; the speech device will be actuated to alert the drivers or passengers not to open the door.

### BRIEF DESCRIPTION OF THE DRAWINGS

FIG. 1 is a schematic view about the arrangement of the present invention.

FIG. 2 is a block diagram about the operation of the present invention.

FIG. 3 is a reference view about the operation state of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

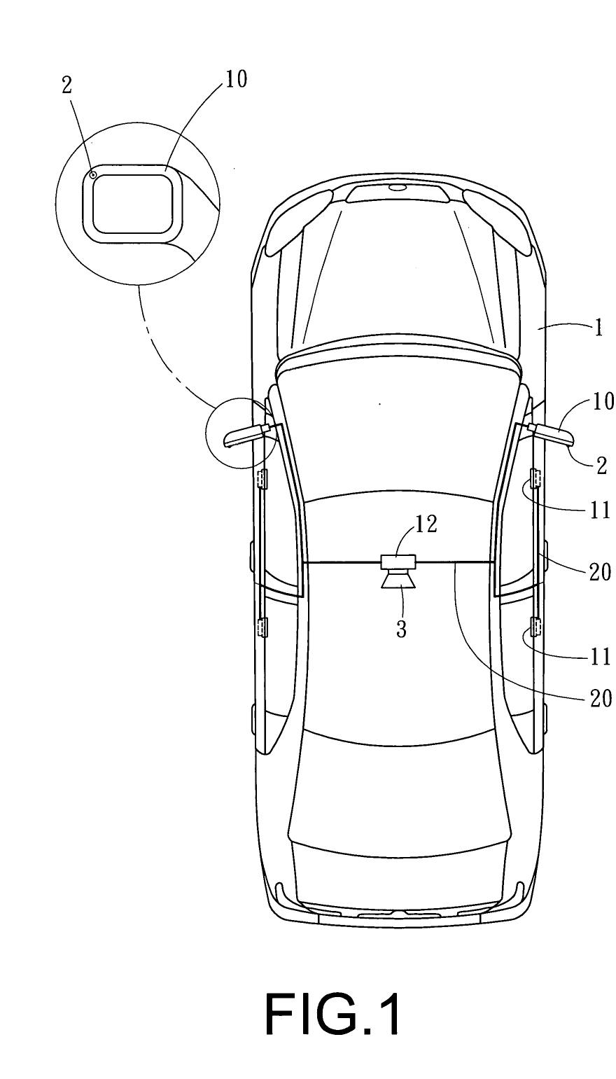

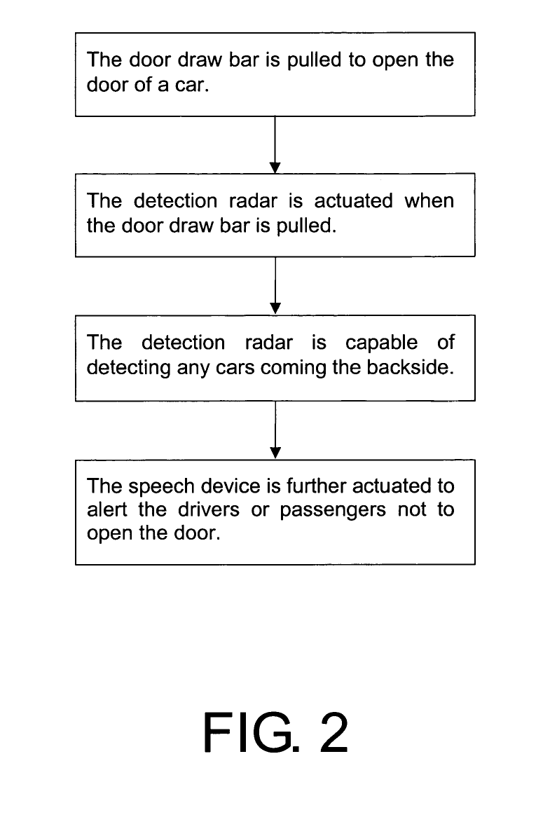

Referring to FIGS. 1 and 2, two rear view mirrors 10 are installed at two sides of a vehicle 1. Each rear view mirror 10 is installed with a detection radar 2. Each radar 2 has conductive wires 20. The conductive wires 20 are connected to a door draw bar 11. The conductive wires 20 of the detection radar 2 are also connected to a car inside light 12. A speech device 3 is connected to the car inside light 12 for informing or alerting the driver that there are cars come from the back side of the vehicle.

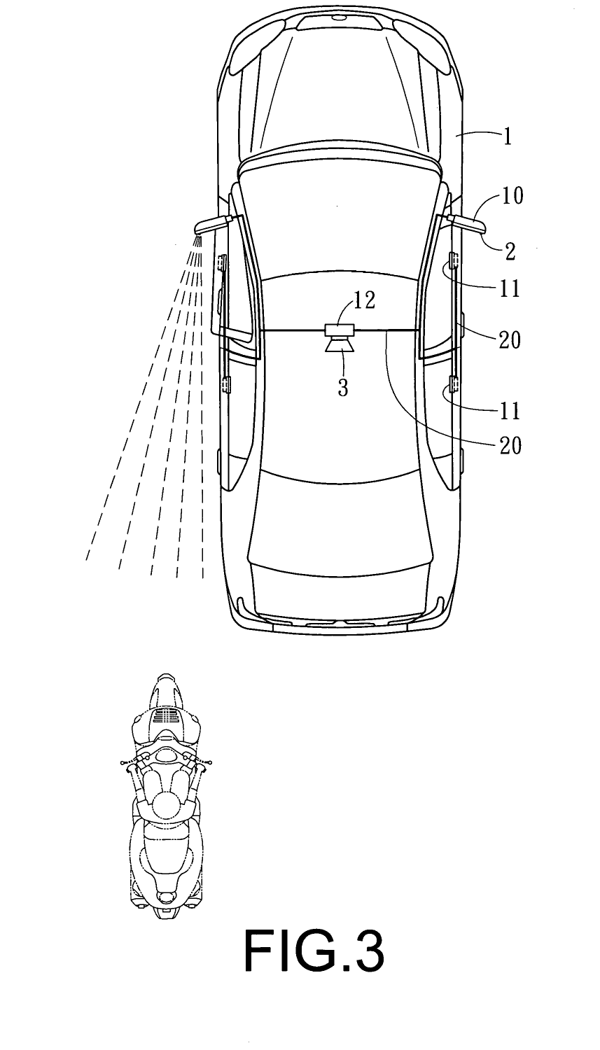

In operation, referring to FIGS. 1 to 3, when the vehicle is stopped, the driver or passenger desire to open the door to leave from the car. Firstly, the draw bar 11 is pulled so as to actuate the detection radar 2. When the radar 2 detects that there are cars come from the backside. The speech device 3 will be actuated to alert the drivers or passengers not to open the door.

Thereby the car door will not be collided by the cars from the backside and the drivers or passengers will not hurt by the back side cars.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An alarm device for altering opening of a vehicle door; two rear view mirrors being installed at two sides of a vehicle; each rear view mirror being installed with a detection radar; each radar having conductive wires; the conductive wires being connected to a door draw bar and a speech device for informing or alerting the driver that there are cars come from the back side of the vehicle;
wherein when the vehicle is stopped, the driver or passenger desire to open the door to leave from the car, the draw bar is pulled so as to actuate the detection radar; when the radar detects that there are cars come from the backside; the speech device will be actuated to alert the drivers or passengers not to open the door.

2. The alarm device for altering opening of a vehicle door as claimed in claim 1, wherein the conductive wires of the detection radar is connected to a car inside light.
